(19) United States
(12) Patent Application Publication
(10) Pub. No.: US 2008/0010664 A1
(43) Pub. Date: Jan. 10, 2008

(54) Method and System for Providing Interactive Services in Digital Television

(76) Inventors: Maurizio Pelizza, Torino (IT); Luigi Quattrocchi, Torino (IT); Laura Contin, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/660,863

(22) PCT Filed: Aug. 30, 2004
(86) PCT No.: PCT/EP04/09633

§ 371 Date: Feb. 22, 2007

(51) Int. Cl. H04N 7/173

(52) U.S. Cl. 725/134

(57) ABSTRACT

A method and system for providing interactive services on a digital receiving device (e.g., a set-top box) linked to a screen. The interactive services include media content that can be displayed on the screen. Interactive services are provided by a service application running in the digital receiving device that includes a dynamic service logic that is able to generate new media content to be visualized on the screen. The dynamic service logic is an application logic that provides the capability of creating dynamic information on-the-fly by using data, which are either stored in the service application or downloaded from a server. These data include the “raw” information content, which will be worked out to produce the script visual representation. The dynamic service logic includes one or more business logics, which are responsible for the client-side production at run time of context-dependent content, e.g., following a user's request. Interactive services can be played also in a set-top box with no return channel as the application running in the set-top box includes the dynamic service logic that can locally create the dynamic scenes that provide for the interactivity.

### FIELD OF THE INVENTION

The present invention relates to a system and method for enabling and processing the interactive television content to a digital receiving device, such as a set-top box.

### BACKGROUND

With the recent advent of digital transmission technology, broadcasters are now capable of providing much more than the traditional analog broadcast video. Although digital transmission requires considerable more bandwidth than analog transmission, the digital signal can be compressed. Computer techniques, such as MPEG (acronym for Moving Picture Expert Group) standards, are used to isolate out and transmit only the changes taking places between one image and the next following. The digital television allows the broadcasting of data, making possible the introduction of interactive services in digital television environment.

Transmission of digital signals may occur in different ways. In digital terrestrial television (DTT) networks, the broadcast signal is transmitted “over the air” to an antenna. In addition to terrestrial, cable and satellite, IP systems are viable means to bring television into a household and provide users a means to receive video, audio and data content.

Today, most viewers receive digital television via a set-top box (STB), which decodes digital signals and displays them on the television monitor (or on a PC monitor, in case of dual-screen systems). Advanced STBs can be more than just decoders and may be programmed to execute applications that can interact with the user through the use of the remote control and with service providers using a modem and the communications network, e.g., PSTN. In practice, the STB typically comprises a computer that runs software, which decodes the signal and executes the software that is transmitted together with the audio or video streams. STBs for one-way systems can access the information and superimpose it on the TV screen. Two-way systems send information back to the broadcaster (or to a service provider) through a return channel. In one-way systems, interactivity is limited to the information locally available (e.g. the user can navigate the pages available on the STB), whereas in two-way systems the user can interact with a remote server (e.g. to request service or to send information).

Return channel is the physical path used by the STB to make the client to interact with a server. For example, Interactive TV users can transmit information (e.g. votes, questionnaires, requests for a service) back to a service center through the return channel. The physical path can be a wired connection, such as a telephone or an ADSL modem line, or wireless, e.g., GPRS or UMTS.

Within the context of digital television, interactivity is generally understood to mean enabling television viewers to interact with programs and services. Interactivity is sometimes divided in two types: enhanced television and interactive services. Enhanced television generally means that the viewer can do more than passively watch a television program. This system allows viewers to simultaneously watch an enhanced television program while downloading additional information related to the program. In enhanced television, the interactivity is of “low-level” and is very similar to the browsing through pages, such as it occurs in analogue television teletext application.

Interactive services generally presume the delivery of information in response to an external event, such as a user's pressing a menu's option or a content up-date. Such information is context-dependent and can be created on-the-fly. Interactive services then can go beyond the functionalities that enable exploring the transport-stream for announcements about current and upcoming programs or for static information, such as those related to an electronic programming guide (EPG). An example of interactive services can be transaction services provided by electronic retailers or delivery on-demand of information on scheduled flights from a certain airport. Interactive services involve accessing information that can be either content-related, i.e., dependent on the broadcasted TV content, or independent from any programming stream. The difference between content-related services and stream-independent services often lies in whom the service provider contracts with to create or deliver the service, i.e., the TV channel provider (broadcaster) or the MVPD (Multichannel Video Program Distributor), the latter acting as platform operator. By way of example, in practice, the delivery on-demand of financial information and stock quotes can be program-related along with a business channel or having no relation to a specific programming stream.

Hereafter, interactive services will mean to include both programming enhancements involving interactivity and dedicated interactive services independent from any programming stream.

Interactive services are delivered either through the same broadcast channel that provides the TV content or through a separate transmission line, i.e., a network connection. The method of accessing interactive services is typically through a remote control or a remote keyboard sending an infrared signal to the decoder.

Many of these services are becoming available via the Web. Advanced set-top boxes capable of receiving extra channels in the form of web services have begun to be commercially available. Connectivity to the Internet can be given by an inbuilt modem or by a WiFi or Ethernet connection to a broadband home network.

The STB receives a digital broadcast signal that typically comprises video, audio and data components. The data component is provided by a repetitive “carousel” type manner, with modules being downloaded by the receiver as and when they are required. The modules typically contain interactive applications written in Java® programming language. The STB is provided with a Java Virtual Machine (JVM) and receives Java class files that it links and executes to run the interactive application.

The STB generally needs a middleware to launch the applications. Middleware is software and hardware resident in the STB, which help applications work together. Middleware providers develop software and interfaces that allow users to select programming and products, connect to the Internet, and make secure transactions. Examples of middleware are Liberate, Open TV, Microsoft TV and Java TV.

Java is an object-oriented-programming language that is platform independent. Java is specifically designed to create small programs, commonly called applets, which can reside on the network in centralized servers, and delivered to the client machine only when needed. A Java program can be written once and run on any type of platform that contains a JVM. Being an object-oriented language, the software written in Java can take advantage of the benefits of object-oriented programming. In the Java language, program data is wrapped in a class, whether it is a class the programmer creates or a class used from the Java platform API (Application Programming Interfaces) libraries. A class contains both data and executable code (referred also to as methods), to work on that data. Within Java, an object is the runtime instance of a class whose behavior is defined in methods. A program written in Java is first compiled into byte codes using the Java Compiler. Byte codes are platform independent commands that can be interpreted and run by a JVM. The JVM is a virtual computer that must be implemented for each platform on which the Java program must be run. The JVM provides a layer of abstraction between the compiled byte codes and the underlying hardware platform and operating system. When the JVM executes a program, it takes the Java byte codes and interprets or converts them to machine code instructions for the underlying hardware, and passes the machine code instructions to the CPU for execution. By working in such a manner, Java programs can be written once and run on any platform for which a JVM is available.

An emerging standard platform for interactive television (iTV) is the Multimedia Home Platform (MHP), which is an open middleware system designed by the Digital Video Broadcasting (DVB), an industry-led consortium that standardizes various aspects of digital TV broadcasting. MHP is a set of APIs allowing all third parties to develop and operate their own iTV applications. MHP is generally defined in Java run-time environment, e.g., based on Sun's JavaTV network.

A DVB-MHP application can be categorized either as DVB-Java or DVB-HTML application. DVB-Java (or DBV-J) applications are generally called Xlet applications. They all run in STB and they can be resident either in the STB or being downloaded from objects and data carousels or network. An Xlet application is controlled by an application manager, which is part of the system software and is resident in the STB. The application manager is responsible for managing the application lifecycle.

C. Peng and P. Vuorimaa in “Digital Television Application Manager”, published in Proceedings of the IEEE International Conference on Multimedia and Expo 2001, Tokyo (Japan), Aug. 22-25, 2001, pp. 685-688, presents a design of an application manager in a platform for access multimedia services in DVB-MHP standard. A DVB-J application is actually a set of Java classes that operate together and need to be signaled as a single instance to the application manager so that it can control its state changes. In the paper, all information of downloadable applications is stored in an Application Information Table (AIT), which is multiplexed and transmitted together with other elementary streams in MPEG-2 transport stream. The application manager needs this information to identify the location and signaling information of the applications. To this purpose, the Java class loader and class technology of JVM were used to load application classes from different sources and solve name collision.

Generally, a navigator or an electronic programming guide (EPG) is used to present a graphical interface to the user for selecting a service. Once the service is selected, an Xlet is downloaded to the DVB terminal, which presents a graphical interface for the user to select functions that the Xlet provides. J. Cosmas et al. in “Providing Fast Prototypes of Services and Automated Generation of Service Applications for Converged Broadcast and Cellular Networks”, downloaded from Internet at www.ist-overdrive.org/HyWiN2003/proceedings/2.41.Hywin-PaperServices2003-11-16.pdf on Jul. 5, 2004, disclose a user interface that provides a generic graphical presentation engine operating underneath the graphical user interface that presents the service-user interface to the user. The presentation engine operates by interpreting metadata, captures the user's interactions via the graphical user interface and executes the corresponding commands described by the metadata.

WO 03/104980 acknowledges the problem of the relatively low data rate used by the broadcaster, which leads to a detectable delay in data transfer. The patent application describes a method for operating a JVM comprising loading a module including a parent Java class file and identifying offspring Java class files listed within the parent Java class file. The parent Java class file is executed concurrently with the preloading of the offspring Java class files.

US 2004/0031052 discloses a CATV system that provides communications between applications servers and a subscriber STB on which a TV navigator is running. The TV navigator is a middleware environment to which all content and applications are written. Applications reside on top of the middleware. Content and applications are written entirely in industry standard HTML and Java. Traditional television content is integrated with Web content using TV-specific extensions to HTML and Java.

Enhanced television content is typically presented using a combination of HTML, JavaScript, Java and other Web technologies. WO 02/17639 discloses a system and method that parses a text-based script enhancement file to produce platform-dependent enhancement files. The script file may be of XML (eXtensible Mark-up Language) format and a parser may be a XSL (eXtensible Stylesheet Language) translator. The parser may import HTML and JavaScript from other applications.

Within the Internet environment, interactivity of Web sites has been recently enhanced by the creation of dynamic Web pages typically used in question-answers or betting systems. The systems can be set-up by using Java Web Server running on a software platform. The server uses Java Servlets to handle the requests from customers, to connect the database servers and to generate dynamic content from the Web browser.

C. Peng and P. Vuorimaa in “Interactive Digital Teletext Service” published in Proceedings of the 6^{th} World Multiconference on Systematics, Cybernetics and Informatics, Jul. 14-18, 2002, describe a Java-XML based solution, which can add two-way communications to the digital Teletext service by using a return channel provided by digital television infrastructure. The approach is based on a client/server model and utilizes XML based messanging mechanism and Java Servlet technology.

Applicants have noted that technologies using Java Servlets for the creation of dynamic pages are based on a client-server architecture, in which the service logic lies at the server side, whereas the presentation is present on the client side. They have observed that in case when the STB does not use a return channel it is not possible to provide dynamical content, which can be updated by the interaction with the user, to the STB.

A significant problem for the deployment of iTV applications is that most of the commercially available STBs have a limited amount of the onboard memory with which to store and process iTV applications.

Applicants have observed that interactivity can be advantageously maintained in lightweight STBs when the received interactive content is represented in XML.

XML is a subset of Standard Generalized Markup Language (SGML). SGML is an international standard for the description of marked-up electronic texts and is a metalanguage (a means of formally describing a language). SGML specifies what markup is allowed, what markup is required, and how markup is to be distinguished from text. “Markup” generally uses “tags,” which are specific words that have particular meanings. Tags allow a programmer to formulate a set of rules through which a document is to be validated. In XML, tags identify elements in documents and contain attributes about these elements. They represent data description or data relationship, providing a mechanism for links between multiple resources.

### SUMMARY OF THE INVENTION

The present invention relates to a method and system for providing interactive services on a digital receiving device, said interactive services including media content that can be displayed onto a screen. Media content is described by description files that represent the scenes that are visualized on the viewer's screen. Description files include the information, preferably in a markup language content format, on how a scene is to be constructed on the screen. A scene comprises at least graphical elements. In addition, scenes can comprise a background (still image) and a video content. The video content can comprise animations, images or motion pictures and can be, but not necessarily, combined with an audio signal. The digital receiving device is a device including hardware and software, which receives and plays the interactive services. The interactive services are visualized onto a screen, e.g., TV screen and PC monitor. Preferably, the digital receiving device receives also a digital TV signal that is displayed to the viewer's screen. Preferably, the digital receiving device is a digital set-top box (STB) operatively linked to a viewer's television.

In practice, the interactive services correspond to software applications that run in the digital receiving device. Software applications can be launched in the digital receiving device following a client's invocation, i.e., consequent for instance to a user's request. Applications can be downloaded from the server that can be resident in a remote network, such as the Internet or a broadcast channel. Besides being invoked by a user's request as in case of pull-type services, applications can be launched in push mode, i.e., the client automatically launches an application when the server sends information, for instance due to the fact that new content becomes available. Alternatively, applications can be already resident in the client and can be auto-started or activated by a user. The present invention is suitable for both broadcast applications that can be downloaded and/or launched in the receiving device and for resident applications.

Hereafter, a software application that can provide interactive services will be referred to as service application.

Applicants have found that if the service application that provides the interactive service includes a dynamic service logic, media content can be dynamically generated at the client side. The dynamic service logic is an application logic that provides the capability of creating dynamic information on-the-fly by using data, which are either stored in the service application self or downloaded from a server. The dynamic service logic comprises one or more business logics, which are responsible for the client-side production at run time of context-dependent content, e.g., following a user's request. Within this context, a business logic is a software functional process component that performs logical operations on (some) user data, for example in order to transform, organize the data or combine them with other information. The business logics are “launched”, i.e., instantiated, by a software component called logic manager, which also provides the business logics an access to the user data on which the logical operations defined by the business logic can be performed. Logical operations on the user data generate on-the-fly “new” media content, which will be visualized on the screen. User data include the “raw” information content, which will be worked out to produce the script visual representation.

Preferably, the dynamic service logic is defined as a set of Java classes. Java classes can be instantiated in the runtime environment of the client platform.

The digital receiving device includes a virtual machine that can execute the service logic. Preferably, the logic manager is the part of the client platform that is common to more than one application, whereas the business logics are application-specific components of the service logic. Both the business logic(s) and the logic manager are included in the dynamic service logic comprised in the service application.

While the detailed description uses the example of a client/STB, the present invention applies to all client devices including personal digital assistants (PDAs), cell phones, pocket personal computers or any other types of electronic device capable of receiving an electronic signal and of transmitting it to a motion picture display device, such as a television. In case of the software application is implemented on a cell phone, the display device can be the in-built display of the phone or a DTV docked station to which the cell phone can be connected.

One of the advantages of the present invention is that interactive services can be played also in STB with no return channel as the application running in the STB includes the service logic that can locally create the dynamic scenes that provide for the interactivity.

A service application according to the present invention comprises the raw application data and an executable code portion. The executable code portion includes first executable codes for displaying the media content on the screen and second executable codes included in the dynamic service logic, said second executable codes being able to generate new media content.

Preferably, the raw information data, which can be worked out to create the new media content, are formatted using markup languages such as HTML, WML and XML, at least for the portions of data that do not contain multimedia files (e.g., motion pictures, images and music), i.e., the user data. More preferably, the format described using XML standards.

### DETAILED DESCRIPTION

A service application generally comprises a sequence of scenes. A scene is the “visual” construction of the media content on the screen. In other words, a scene is the visual (and audio in case sounds are included in the media content) perception of the delivered media content by the screen's viewer. A scene can comprise also a digital TV signal as in case the interactive service overlaps at least partially a broadcasted program. Media content can comprise background (still pictures), video (motion pictures or images) and graphical elements including text and graphics. Graphical elements are represented by graphical components, which define the functions that allow the selection of an element, properties when selected or, in general, an action to an element.

A scene can be represented as a collection of elements, such as text, audio, video, music files, each or any combination of them giving raise to both still and/or motion images, texts and sounds. Scenes can be static, i.e., their content is entirely defined when the application is created, or dynamic, i.e., (part of) their content is not defined when the application is generated, but it is context-dependent, e.g., it is created following a user's request or a data up-date. In other words, a dynamic scene is created and delivered on-the-fly, e.g., in the runtime environment of the STB.

Static scenes can be explored during navigation with functionalities similar to Web browsing and hypermedia linking (i.e., hyperlinking). The functionalities related to navigation through scenes and inside a scene without generation of new content will be also referred to as local interactivity, although this implies a “low level” interactivity.

As a service application is usually transmitted concurrently with a digital TV signal, graphical components can, but this is not necessary, overlap both partially or completely the displayed TV images. For instance, the TV signal can be resized and played in a window included in the scene. Examples of elements that are included in a scene are: a text list that can be scrolled on a TV screen, a field in which a text can be inserted, a selectable menu of mutually excluding options, and a graphical element to which a URL (Uniform Resource Locator) is associated as forward link to a Web page.

In the particular case that the software application is a Web application, the scenes are Web pages, e.g., HTML or XHTML data transmitted from the Internet.

Software applications preferably run in Java, but this is not essential. It should be appreciated that the overall system is software based and developed using an object-oriented programming language. Application data, at least those that do not contain multimedia content, are preferably described by using a markup language, such as XML.

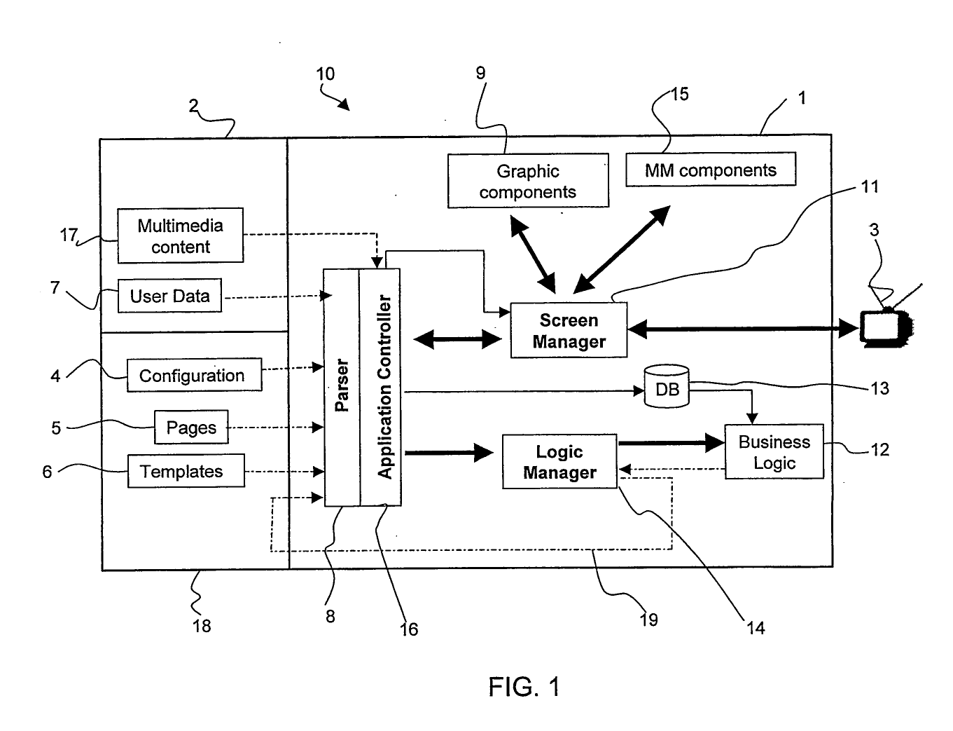

FIG. 1 schematically depicts a service application 10 that is provided to a digital receiving device for receiving media content to be displayed on a screen, according to an embodiment of the present invention. For example, the application can be downloaded from a broadcast channel or from a communications network. In the present embodiment, the service application 10 is launched in a STB, which is linked, e.g., by means of a TV-SCART cable, to a TV screen 3 that displays the interactive services. A digital-to-analog converter (not shown in FIG. 1) may be interconnected between the computer hardware of the STB and the TV screen to convert the digital signals into analogical signals in case of an analogical TV display system. Application 10 includes an application executable portion 1, raw application data 2 and description files (18), wherein the two latter portions (2 and 18) of the application contain data not including executable codes. The raw application data 2 can be specific to a particular application. The executable application portion 1 comprises a middleware software layer, referred in the following to as ‘platform’ or ‘client platform’, containing software modules including executable program, namely a Parser 8, an Application Controller 16, a Logic Manager 14, a Screen Manager 11 and Graphic components 9 and multimedia (MM) components 15. The executable application portion 1 also includes application-specific modules, namely a Business Logic software module 12. The distinction between platform and application-specific logical units is to be understood only as a preferred implementation as seen from the side of the software developer, but it should not be considered limitative.

The application executable portion 1 includes first and second executable codes, wherein the first executable codes are included in the Screen Manager 11 and in the Graphical Components 9 (and preferably the MM components 15) and the Logic Manager 14 and the Business Logic 12 include the second executable codes. Preferably, the application executable portion includes the Parser 8 and the Application Controller 16.

Some applications may need to build one or more internal databases, in which raw data, either textual or multimedia, are stored into a format that can be read and understood by the software modules of the executable portion of the application or they can organize the data in a suitable way to be used by those software modules. In the embodiment illustrated in FIG. 1, the application 10 includes a database (DB) 13. Although DB 13 is graphically represented in FIG. 1 in the executable portion 1 of the application 10, it is to be understood that it does not contain executable codes.

Within the present embodiment, the platform contains the part of executable software, which can be not specific to a particular application. The platform can be for instance used by the application developers to generate different interactive services, i.e., different applications that can run in a STB. It is to be understood that the platform of the service application is a middleware layer that is placed at the application level, which is a higher level than that of the middleware layer typically resident in a STB, such as the MHP. The platform can be permanently resident in the STB, but this implies that the capacity of the persistent storage in the STB is sufficiently large. In case of STB with limited hardware resources, the platform (and actually the service application) runs in the runtime, e.g., the volatile cache memory, of the STB.

As it will become clear from the following discussion, the Business Logic 12 and the Logic Manager 14 are included in the dynamic service logic of the service application, which allows the creation at the client side of context-dependent media content.

An executable code is an (or a piece of) executable program, which is often treated as a file containing a sequence of instructions. Executable codes are referred also to as methods. In the preferred embodiments, the executable codes (methods) of the application are intermediate codes, such as byte codes or p-codes, which are compiled files (i.e. an object code) understood by a processor. In order to be able to execute the codes of the software application 10, the STB is provided with a virtual machine, which is a piece of software capable of executing the codes and of creating an environment between the computer platform, i.e., the underlying computer system on which application programs can run, and the end user in which the end user can operate software. In particular, the virtual machine is a program written in native code on the host hardware (e.g., the computer hardware resident in the STB) that translates generic intermediate code into usable code on the hardware. Preferably, the virtual machine system is a Java Virtual Machine (JVM) that runs Java executable applications. In particular, the JVM reads Java classes and executes the executable portion of the class files.

The STB of the embodiment shown in FIG. 1 has no return channel. The raw application data 2 include User Data 7 and Multimedia content 17, whereas description files 18 include a Configuration file 4, description files for the definition of static scenes called Pages 5, template files for the description of dynamic scenes called Templates 6. The User Data 7 represents the textual information to be conveyed to the end user, such as the complete train timetable in an application for an interactive service providing on-demand schedule for a particular destination. The User Data includes the “raw” textual information content, which will be elaborated to produce the text to be visualized. The text can of course include symbols, bullets or other fields that are typically included in a script visual representation.

The component Multimedia Content 17 contains the multimedia files, which have not been elaborated, possibly together with other graphical elements, for the building of a scene. Examples of multimedia files are a background photo, an icon, an animation, a sound or a music piece. Multimedia files can be in different formats, such as JPEG, GIF, PNG and MP3.

Description files 18 represent the scenes that will be visualized on the screen. As it will become clearer in the following, in case of interactive services, some of description files, namely the template files 6, contain the link(s) to the programs (i.e., executable codes) that allow the creation of new media content based on some particular application data. In other words, the template files do not contain the description of the entire scene, because a part of the scene, e.g., informative content, still has to be created.

The Configuration file 4 is used in the launch phase of the application and contains information relative to the initialization of the Graphic Components 9 and multimedia (MM) components 15 that are common to all the scenes of the applications for defining for instance the background, logos, the layout of the footer for the menu options or its location and size on the TV screen.

Pages 5 include a set of description files, which are used to describe static scenes (e.g., for informative Web pages), where the contents are established when the application is created, e.g. by service developers at the developing phase. Description files are not changed at runtime. The description files include the complete description of how a scene will be rendered on the TV screen and how the local interactivity, e.g., browsing, has to be managed. The description file calls the methods in the Graphic Components 9. Graphic components define for instance format and position of contents and their relationship (e.g. a content depends on where is the focus, a content appears after another content has finished to be displayed). In particular, if the description file is in XML format, the description file contains XML tags, each tag pointing to a specific graphic component; the attributes associated to the tag corresponding to method(s) of that graphic component. Methods are invoked by the Screen Manager 11. Within Java, a graphic component is represented by a class and the attributes of the XML tag include the class name of that class in the Graphic Components. The tag attributes correspond to methods associated to that class and the Screen Manager instantiates that class by creating a runtime object. These XML tags can be referred to as “descriptive” XML tags because they are used to describe how contents should be presented in the scene, not to be confused with the “invoke” tags (or “user data” tags) included in the Templates, which are used to implement advanced interactivity features, as it will be described in detail later. In case of static scenes, only descriptive tags are used and the only “interactivity” supported is the hyperlinking that enables for example the navigations within and throughout the scenes.

The module 6 Templates is used in case of dynamic contents, i.e., contents produced ‘on-the-fly’, which are context-dependent. The component Templates includes at least one template file and in general includes a collection of template files. A template file can be considered similar to a description file, but it supports the creation of dynamic information by containing the link(s) to the logical elements of the dynamic service application logic, which build the dynamic information, as it will be explained more in detail below. In particular, in case of dynamic scene, the template file relative to that scene is described in a markup language, preferably XML, and includes an “invoke” tag that is a logical link to the action of invoking a method in the dynamic service logic. The dynamic service logic is included in the executable portion 1 of the application 10 and comprises a Logic Manager 14 and a Business Logic component 12. In particular, the invoke tag requests the Logic Manager the execution of a program that is included in a specific business logic (i.e., specified in the tag) in Business Logic unit 12. In other words, the invoke tag requests the instantation of a business logic that performs specific logical operations on given user data. The business logics are instantiated by the Logic Manager, which acts as some kind of logical interface between the other parts of the client platform and the Business Logic. The Logic Manager controls the flow of requests of execution of the business logics and receives the output files from the execution, thus controlling also the flow of output files. The Logic Manager instantiates the business logics by calling the methods in the programs in the Business Logic, provides the data on which logical operations needs to be performed and collects the result of the logical operations, i.e., the output of the business logics. In particular, when instantiated, the business logic receives the content by the Logic Manager that provides an access to that content, e.g., by means of a data pointer (i.e. an operative link) to DB 13 or to a specific portion of it.

Preferably, the Business Logic is external to the platform, whereas the Logic Manager is included in the platform. This is because the Business Logic can contain the business logics specific to a particular service application so that the platform can contain programs that are common to more than one application.

Preferably, application data use XML as generic content format of the description files 18, and of the user data 7 (i.e, excluding images or sounds). This has the advantages of integrating content from heterogeneous sources. In addition, the message-oriented approach is suitable for transmission of information over the GPRS, the Internet or the broadcast channel as the dimension of the messages is relatively small, e.g., smaller than that of HTML files for the interactive TV (e.g. DVB-HTML). Configuration file 4, Pages 5, Templates 6 and User Data 7 are thus preferably in XML format. Multimedia content 17 contains multimedia files, comprising for example photos, music, video-clips, which can be represented in different formats, such as MPEG, JPEG, MP2, etc.

Parser 8 is in general terms a computer program or a component of a program that analyzes the grammatical structure of an input file with respect to a given formal grammar, i.e., the description of a formal language, this process being known as parsing. Within a markup language-based architecture, e.g., XML-based, the Parser is a program, e.g., is a piece of Java software, that can read files in markup language. The Parser then breaks the input document into building blocks, (e.g., in XML tags and in parts of the tags), i.e., it parses the input document so that it can then be managed by other programs. In particular, the Parser 8 can read the XML files forming the Configuration 4, Descriptions 5, Template 6 and User Data 7 and “translates” them to the Application Controller 16.

The Application Controller 16 is a (or piece of) computer program that sends commands, e.g., XML tags, either to the Screen Manager 11 or to the Logic Manager 14, depending on whether the action to be performed is the elaboration of static information or of dynamic information, respectively. The Application Controller functions as a sort of logical coordinator of the (parsed) information originating from the raw application data and the description files. Furthermore, the Application Controller receives requests from the Screen Manager corresponding to events triggered by the user interaction.

Although they are represented in FIG. 1 as two distinct software modules to separate their respective logical functions, the Parser and the Application Controller can be a single executable program, for instance they can be different methods of the same Java class.

The Screen Manager 11 receives inputs from the Application Controller 16 concerning the construction and management of the Graphic Components 9. These inputs are contained in the description files 18. In particular, it receives information about the Graphic Components, their attributes (e.g. dimension, position, color and text formatting) and behavior (e.g. change of color when they get the focus). In other words, the Screen Manager 11 manages the Graphic components 9 and it is responsible for the image rendering and the focus management on the TV screen. Furthermore, the Screen Manager converts the user's actions into requests to the Application Controller.

Graphic components 9 represent the graphic libraries that can be either common to more than one service application (e.g. combo box, scrolling list) or specific to the particular application (e.g. logos, background and virtual keyboard). Examples of graphical components are a combo box or a radio button. In Java, the graphical components are organized in Graphical User Interfaces (GUIs), often called widgets or controls, which provide an abstraction layer for the low-level drawing and interaction routines. The GUIs include thus the functionality to draw graphics/widgets on TV screen and to input information from a user by means of a remote control. More in general, the GUIs, and in general graphic components, are software tools represented by scene's elements, which mediate between the user and the inner working of the application. Graphic components can be at least in part selectable by the user via a user interface, such as a remote control. In this case, it is possible to define for each graphic component a behavior associated to the user interaction (e.g. circularity of a menu and how to highlight the focused elements).

The Logic Manager 14 is a program that handles the business logics. In the representation of FIG. 1, the business logics are contained in the software module Business Logic 12. The business logics are used to implement advanced interactivity features, such as the production of dynamic contents based on the user actions (e.g. extraction of requested data, combination of data to produce new information, data ordering, etc.). Part of Logic Manger's activity is controlled by the Application Controller 16 that passes the logical links (e.g., the tags) to the Logic Manager, which request the instantiation of the object associated to a specific business logic and execution of its methods. Within Java implementation, the business logic is one or more Java classes (generally one) that is instantiated by the Logic Manager, also represented by a Java class. Both the class that implements the business logic and the method(s) to be run are specified as attributes of the invoke tag. The class associated with the business logic is instantiated on some specific content taken from User Data 7, specified (provided) by the Logic Manager. Preferably, the service application runs in Java and the software modules of the executable of the service application are defined as a set of Java classes. Within Java, the activity of the Logic Manager is based on the Java technology called Reflection, which allows to instantiate objects given the class name, invoke static and instance methods given the method name, and create a class at runtime that implements one or more APIs. The class names are those included in the Business Logic. In correspondence to the invoke tag in the templates, the Application Controller requests the Logic Manager to instantiate one or more objects corresponding to a class of the Business Logic and invoke its methods.

The objects corresponding to the business logics in 12 are instantiated with a data source, which is specified by the Logic Manager. Data are taken for instance from a lookup table, e.g. an XML lookup table, or from a database (in FIG. 1 DB 13), provided that the service application writes the code to interface with it by means of the Parser 8 and the Application Controller 16. Therefore, the external data source is either the User Data 7 (or part of it) or a lookup table or database, which contain data extracted from User Data, wherein said extracted data if necessary are parsed in a suitable data structure.

In practice, database (DB) 13 is created by the Logic Manager 14, to store the User Data 7 in a suitable structure that can be handled by the Business Logic. In other words, a method of the Logic Manager takes the parsed user data from the Parser 8 and organizes them into a format and structure, which are readable by the Business Logic. Within Java, a method in the Logic Manager organizes the parsed User Data to construct a Java structure, such as a hashtable, which is often organized as an array of linked lists.

In the preferred embodiments, the (part of) user data to be used with the instantiation of a business logic are defined by a “user-data” tag, which can be included either in the Configuration 4 or in the Templates 6. When reading the user-data tag, the Application Controller passes the tag to the Logic Manager. A method in the Logic Manager takes the (portion of) data defined in the attributes of the user-data tag and creates a data structure in DB 13, which is described by a data pointer. This data pointer will be provided by the Logic Manager to the business logic invoked by the invoke tag when instantiation of that business logic is requested.

When the application is launched in the STB, the Parser 8 reads the Configuration file 4 that provides the information on the common files to be used, e.g., stylesheet and polling data, and includes a link to the first scene to be visualized. If the first scene is static, the link will be to a description file in Pages 5. If the first scene is dynamic, the link will be to a template file in Templates 6. Preferably, the Configuration, Pages, Templates and User Data are XML files. Thus, preferably, the Configuration is an XML file that contains a tag that is used to identify the first scene to be presented on the screen. This tag is analogous to the tag used in the web applications to identify the index page. The first scene is described by an XML file that can be either a description file (static) or a template file (dynamic). Then, the Parser starts analyzing the description or template file and passes the parsed information of the file to the Application Controller. In dependence on whether the first scene is static or dynamic, the Application Controller handles the application data following different logical procedures.

If the first scene is static, no external (i.e., external to the platform) methods, i.e., the business logics, are recalled because no invoke tag is read by the Application Controller. The Application Controller passes the parsed data from a description file in Pages 5 to the Screen Manager, which employs it to build and manage the scene. The parsed data include, but they are not limited to, information about: 1) what element is to be included in the scene, such as a menu, a combo-box and a window displaying a resized TV signal; 2) attributes of the displayed elements, such as dimension, position and graphical characteristics (e.g., color, font type, size, etc.); and 3) element's behavior that defines how an element visually behaves following an external input for instance as a consequence to user's interaction. The behavior of an element can comprise how the element can be focused on the screen, whether it is observable by other elements, i.e., other objects can “see” the object status and they can change their status in accordance to the status of the observed object (this function is for instance defined in DVB-Java). The parsed data can contain also the static text to be included in the elements (e.g., an item, in a menu) or the URL to multimedia content contained in Multimedia Content module 17. Finally, these data can comprise information suitable to manage the scene, such as a navigation path within the scene, the URL to a new scene or the event that brings a change of scene, the event being for instance the user's pressing of a key or the elapsed time. The Application Controller recognizes through the plain text the “descriptive tags”, the “elements” of the scene, i.e., the implementations of the graphic components, their position and their properties. The Graphic Components' implementations include the structure of the scene, comprising the visual organization on the screen and their properties include the elements' behavior, i.e., how an element behaves following the user's interaction. Examples of behavior of scene's implementations are a change of color or font and a pop-up of a window consequent to a selection of a menu's option. In XML, the behavior is identified by an attribute of a descriptive tag included in a description (or a template) file. The information is passed from the Graphic Components to the Screen Manager.

Regarding the content of the scene, multimedia content is taken from 17, which includes multimedia files (e.g., MPEG-1, JPEG, GIF, PNG, MP3), whereas user data content are taken from the DB 13. To build the scene, the Screen Manager 11 calls the methods in the Graphic and (MM) components 9 and 15, respectively. In MHP standard, the graphic components are taken from the graphic libraries, such as HAVI (Home Audio-Video Interoperability) or Java AWT (Abstract Window Toolkit) APIs. MM components 15 include programs, e.g., Java classes, which allow the execution of a MM file, such as the playing of a music piece from a MP3 file. Examples of MM components are thus a music player or a video player, and in general a multimedia player.

Let us now consider the case of a scene that includes dynamic contents, e.g. a list of items that depends on the occurrence of some events such as a soft key pressed by the user. In this case, the scene is described by a template file in Templates 6. The structure and the type of contents of this file are similar to a description file in Pages 5, but it includes at least an invoke tag, i.e., a tag that requests the execution of a program that is external to the platform. When the Application Controller 16 while analyzing a template file finds an invoke tag, it passes the information about the program to be executed to the Logic Manager 14. The invoke tag indicates that one or more business logics in Business Logic 12, which is in this embodiment external to the platform, must be invoked in order to produce on-the-fly a media content associated to the occurred events. In other words, the content to be displayed need to be produced runtime by one or more business logics according to external events.

The parsing process is similar to that described for static scenes until an invoke tag is encountered by the Parser 8. The Application Controller 16 detects the invoke tag and recognizes the associated methods. Within Java implementation, the Application Controller recognizes that the class and methods, which are associated to the invoke tag, are proper of a class of the Business Logic 12. This class (or in general the executable codes) is the implementation of a business logic to be used to produce the dynamic content. When the Application Controller has recognized the recalled class, it “asks” the Logic Manager 14 (by passing the request included in the invoke tag) to instantiate that class by implementing the recalled business logic in 12. The Logic Manager triggers the specified methods in the recalled business logic.

The recalled business logic is instantiated by the Logic Manager with an external data source, in this embodiment DB 13. The template file contains a “user-data” tag that is detected by the Application Controller before the invoke tag. The user-data tag triggers the Logic Manager to extract the data from User Data 7 and to create a data structure, e.g., database (DB) 13, which is described by a data pointer to (a portion of) the user data.

The Logic Manager, when instantiating the business logic requested by the invoke tag, will provide that business logic the data pointer to DB 13.

Instead of being included in the template file, the user-data tag can be embedded in the configuration file in 4. In this case, all necessary data are “downloaded” in the executable portion of the service application, i.e., transformed in a suitable format in DB 13, when the service application is launched. The embodiment in which the user-data tag is present in the template XML file and detectable before the invoke tag is however preferred because it allows the creation of a light DB, in which only the data associated to the recalled business logics are present. As in the preferred embodiments, only a business logic is executed at the time, every time that a new business logic need to be executed, the data associated to that new business logic can be overwritten on the data of the previously executed business logic.

As a result of the logical operation on the input data, the Business Logic produces an XML file including the data 19 to be displayed.

The XML file 19 is returned to the Logic Manager 14, which in turn sends it to the Parser 8. The Parser interprets the XML file 19 and then passes the parsed file to the Application Controller, which passes this “dynamic information” (i.e., just created on-the-fly) to the Screen Manager 11 for the construction of the scene. The Screen Manager inserts this information in the location in the scene specified by the template, e.g., in a specific place in a menu, and produces the graphic object that includes the dynamic contents, by instantiating a suitable method of a graphic component.

For example, the dynamic information can be a new list of items, which need to be produced as a consequence of an external event, e.g., a list of the train stations connected to a particular destination for an application of train schedules. The Application Controller sends to the Screen Manager the information included in the Templates to build the scene. When the Application Controller reads the invoke tag associated to the requested list, it understands that the list of items is not available in the template file, but it must be produced by a business logic. Thus, the Application Controller sends to the Logic Manager the request to produce the dynamic content by invoking the method(s) of the class specified in the Template, e.g., an action induced by the method can be “create a list from the data taken from DB 13” (in this example it is assumed that the data are already present in DB 13). The Logic Manager, by using the Reflection, instantiates the class and invokes the relative method(s). Other examples of actions induced by the methods are the filtering of data from DB 13 according to some criteria specified by the user, merging of some data taken from DB 13, as specified by the user, and ordering and structuring the presentation of the data. The Business Logic returns the XML file 19 to the Logic Manager with the items to be included in the new list. The Logic Manager passes the file 19 to the Parser. These items (embedded in the parsed file) are provided to the Screen Manager, the Parser and Application Controller. The Screen Manager inserts the items in the list and the list the scene as indicated by the Template.

Finally, the scene dynamically built up in the above describe way can be rendered on the TV screen 3. The logical process of the scene building implemented by the Screen Manager and the rendering on the TV screen can be the same as that previously described for the static scene.

It is to be noted that, when the Application Controller reads an invoke tag puts in “stand by” the scene building and passes the information related to the invoke tag to the Logic Manager. According to a preferred embodiment of the present invention, the Java classes that are instantiated at runtime implement the dynamic service logic of the application, i.e., the Logic Manager and the Business Logic. Instantiation of the XML invoke tags into runtime objects, i.e., the execution of the recalled Java classes, implies that objects are created-only when the methods of the Java classes are invoked.

Preferably, only the graphic and/or MM components necessary for the service application are present in 9 and/or 15, whereas other graphic or MM components can be downloaded in runtime only if and when needed.

The first page may point to another page, with functionality similar to a hyperlink. Alternatively, another scene needs to be created consequent to a user's request. For instance, one or more descriptive tags for the graphic component implementation are included within a scene. Following the user's selection of a graphical option on the screen, an attribute of the descriptive tag associated to that selection is an URL to a description file in Pages 5 or to a template file in Templates 6. Template or description files can be stored in the runtime of the STB. The building of the second scene follows the same logic passages as for the building of the first scene, with the same distinction between a static scene and a dynamic scene. It is therefore to be understood that, although the above detailed description referring to FIG. 1 has been made for the building of a scene, namely the first scene, the logic process holds for the building of any scenes that form the service application within the present embodiment (generally, without taking the Configuration 4 if initialization of the application is already performed).

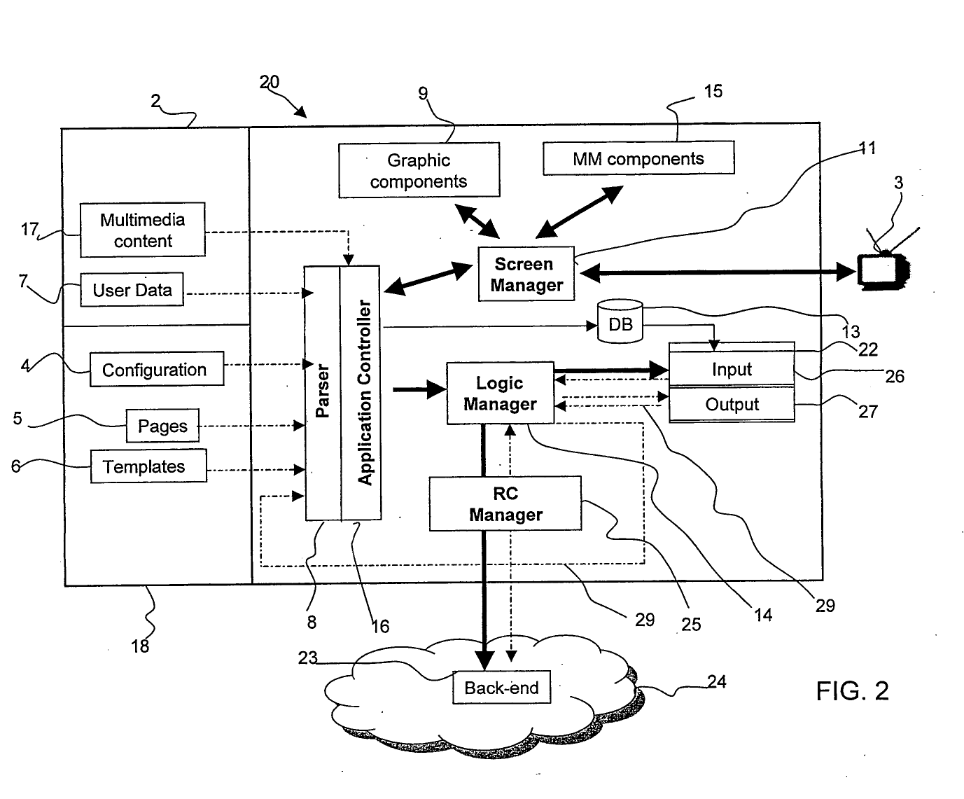

FIG. 2 shows a second embodiment of the present invention, in which the client is directly connected to the back-end of a service center, i.e., a software system that comprises at least a server and can be in particular a distributed system of a plurality of servers. The same reference numerals are given to elements of the service application 20 corresponding to those shown in FIG. 1 and their detailed explanation will be omitted. The STB in this embodiment is provided with a return channel that connects a remote communications network 24 with the client hosting interactive service application 20. Remote network 24 can be for example the IP, the GPRS or the UMTS network. The return channel can be a wired or a wireless physical path.

Return channel can be used to run interactive services based on standard client-server architectures or Web Services. A Web Service is a collection of protocols and standards used for exchanging data between applications. Software applications written in various programming languages and running on various platforms can use Web Services to exchange data over a communications network, generally, the World Wide Web. Web Services reflect a service-oriented architectural approach and are loosely coupled software components that communicate with each other over a communications network generally by using open-standard XML protocols such as SOAP (Simple Object Access Protocol). Service providers can describe the structure of a specific service offered using for instance WSDL (Web Service Description Language), which is an XML-based language.

Within the representation of FIG. 2, the abstraction of separating the client/server system into front-end and back-end will be used. The front-end is the part of the service center that is responsible to collect and process inputs from the user and to convert them in a suitable format, i.e., protocols supported by the server(s), such as HTTP, SOAP. The back-end 23 is the part of the service center that can process the inputs from the front-end and provides the outputs to the front-end. One can see the function of the front-end as an interface between the client and the back-end. Whereas the front-end is typically hosted on the server side, according to the present invention, the front-end is located at the user's premises, e.g., running in a STB, and it is included in the dynamic service logic. As discussed previously, with dynamic service logic, it is meant the logic that provides the capability of creating dynamic information on-the-fly, represented in FIG. 2 with the Logic Manager and the business logics in Business Logic component 22, comprising software components Input 26 and Output 27.

Service application 20 is running in the STB, e.g., it is downloaded from the back-end 23 to a STB. Templates 6 and Pages 5 can be present in the runtime of the STB or being downloaded over the return channel. In the embodiment of FIG. 2, the Business Logic 22 comprises an Input logic 26 and an Output logic 27, which are plugged-in the client platform by the Logic Manager 14. The client platform of the application 20 comprises, besides the Logic Manager 14, the Parser 8, the Application Controller 16, the Screen manager 11, and the Return-Channel (RC) Manager 25. The RC Manager 25 is responsible of the set up and the clear down of the physical connection with the remote network. For instance, in case the return channel is a telephone line connected to a PSTN, the RC Manager is in charge of dialing the telephone number and informing the Logic Manager when the call is open or closed. The client platform comprises also the Graphic and MM components 9 e 15, respectively.

The service application requests services to the back-end 23 (i.e., the server) by sending a specific message to the server. The creation and management of the scenes is similar to that described in the first embodiment. One of the main differences with the first embodiment is that data associated to the business logics can be taken either “locally” from User Data 7, as in the first embodiment, or from the back-end 23.

In this embodiment, the template file comprises an invoke tag that specifies two business logics: the Input logic 26 for asking the user data to the server and the Output logic 27 for handing the answer messages from the server. Similarly to the previous embodiment, the invoke tag requests the Logic Manager to instantiate a business logic on some particular user data. The Logic Manager according to the present embodiment instantiates a business logic in Input 26, which prepares a message including input data, said message being in a format according to the protocol used by the back-end 23, e.g., HTTP and SOAP. For example, input data can be inserted by the user in an electronic request form to be filled-in by using for example the multi-tap function available on the remote control of the STB or a virtual keyboard. The preparation of the message by the business logic in Input can include also logical operations on the input data, such as associating input data with other user data taken from 7.

The business logic in Input 26 asks the Logic Manager to sent the message to the back-end 23. The Logic Manager than sends the message by using the RC Manager 25. In other words, the Logic Manager asks the RC Manager to open a connection towards the back-end 23. When the connection is on, the Logic Manager sends the message received by the Input 26, which includes the input data from the user, to the back-end.

The server elaborates the message including the input data and sends back, as a reply, an answer message to the Logic Manager through the return channel managed by the RC Manager. When the Logic Manager receives the answer message, it instantiates a business logic in Output 27, which converts the answer message into a format readable by the client platform, e.g., an XML format. The output of the Output logic 27 is a set of XML data 29 that the Logic Manager sends to the Parser 8. The Parser interprets the XML data 29 and then passes it to the Application Controller, which passes this “dynamic information” (created by the server and converted by the Output in a suitable format) to the Screen Manager 11 for the construction of the scene. The Screen Manager inserts this information in the location specified by the template and produces the graphic object that includes the dynamic contents, by instantiating a suitable class of a graphic component, e.g., an API in the graphic libraries.

The architecture shown in FIG. 2 has the advantage of allowing the use of the service logic of a web service and of making the communication between the client-side application and the back-end much more efficient because translation and processing of the input data (and/or other user data) are made “locally”, i.e., in the runtime of the STB.

1-38. (canceled)

39. A digital receiving device operatively linked to a screen and configured to receive a television signal that can be displayed onto said screen, said digital receiving device comprising a service application for providing interactive services comprising media content, such media content being described by description files representing a sequence of scenes to be visualized on said screen by running first executable codes, said service application comprising user data and a dynamic service logic comprising second executable codes capable of performing logical operations on said user data, which, executed in the digital receiving device, generate new media content to be visualized on said screen.

40. The digital receiving device of claim 39, wherein the dynamic service logic comprises at least a first software component or business logic capable of executing said second executable codes on said user data and a second software component or logic manager capable of instantiating said second executable codes and of providing the business logic an access to said user data.

41. The device of claim 39, wherein the service application runs in the runtime of the software environment of the device.

42. The device of claim 39, wherein the device is a digital set-top box operatively linked to a viewer's television.

43. The device of claim 39, further comprising a virtual machine capable of processing the first and second executable codes.

44. The device of claim 40, wherein the service application further comprises a first software component or parser capable of parsing the description files and the user data.

45. The device of claim 40, wherein the description files use a markup language content format.

46. The device of claim 45, wherein the markup language is an XML language.

47. The device of claim 44, wherein the description files use a markup language content format and the parser is capable of parsing the description files by converting the markup files representing the description files into documents complaint with first and second executable codes and by extracting the tags and attributes from the markup files.

48. The device of claim 40, wherein the logic manager and the business logic are implemented as Java classes.

49. The device of claim 48, wherein the logic manager instantiates the Java class defining the business logic by using Java reflection technology.

50. The device of claim 48 further comprising a Java virtual machine.

51. The device of claim 40, wherein the user data uses a markup language as content format.

52. The device of claim 51, wherein the markup language is an XML language.

53. The device of claim 45, wherein the description files comprise at least a template file, said template file comprising a first tag or user-data tag capable of requesting the logic manager to acquire the user data and to create a data structure described by a data pointer.

54. The device of claim 53, wherein the data structure is a Java data structure and the business logic is a Java class comprising said second executable codes and data and wherein the data of the Java class comprise said Java data structure.

55. The device of claim 53, wherein the template file further comprises a second tag or invoke tag capable of requesting the logic manager for the instantiation of said second executable codes on said data structure.

56. The device of claim 39, further comprising a feedback device operatively linked to the device capable of receiving input information from a user.

57. The device of claim 56, wherein the service application further comprises second software components or graphic components comprising said first executable codes, the graphic components being capable of displaying the media content on the screen and capable of inputting information from the user by using the feedback device.

58. The device of claim 57, wherein the service application further comprises a third software component or screen manager comprising said first executable codes and capable of receiving instructions contained in the description files for the representation of the scenes and capable of employing these instructions to build the scenes by using the graphic components.

59. The device of claim 58, wherein the graphic components and the screen manager are implemented as Java classes.

60. The device of claim 39, wherein the service application further comprises multimedia content.

61. The device of claim 60, wherein first executable codes comprise multimedia components for playing and displaying the multimedia content.

62. The device of claim 40, further comprising a return channel for connecting the device to a remote communications network.

63. The device of claim 62, wherein the service application further comprises a return channel manager for managing the connection with the remote communication network, said return channel manager being logically linked to the logic manager so as to inform the logic manager on the status of the connection.

64. A method for providing interactive services on at least a digital receiving device operatively linked to a screen, said interactive services comprising media content described by description files representing a sequence of scenes to be visualized on said screen, comprising the steps of:
a) running a service application in the digital receiving device, said service application comprising first executable codes for visualizing the scenes on said screen and a dynamic service logic comprising second executable codes;
b) providing user data to the service application;
c) providing said second executable codes access to the user data; and
d) instantiating said second executable codes on the user data so as to perform logical operations on the user data, which generate new media content to be visualized on said screen.

65. The method of claim 64, wherein the user data uses a markup language as content format.

66. The method of claim 64, wherein the description files use a markup language as content format.

67. The method of claim 65, wherein the markup language is an XML language.

68. The method of claim 66, wherein the markup language is an XML language.

69. The method of claim 64, further comprising the step of parsing the user data before step c).

70. The method of claim 64, wherein step c) comprises the steps of acquiring the user data and of creating a data structure described by a data pointer.

71. The method of claim 66, further comprising the step of parsing the description files before step c), wherein parsing comprises converting the description to a document compliant with the first and second executable codes and extracting tags and attributes from the description files.

72. The method of claim 71, wherein step d) is requested by one or more attributes specified in a first tag or invoke tag in at least a description file.

73. The method of claim 64, wherein the dynamic service logic is implemented as Java classes comprising said second executable codes.

74. The method of claim 73, wherein step d) is carried out by using Java reflection technology.

75. The method of claim 64, wherein the first executable codes are Java compliant.

76. The method of claim 64, further comprising the step of delivering a digital TV signal to the digital receiving device.

77. The method of claim 74, wherein the at least digital receiving device is a digital set-top box operatively linked to a viewer's television.
